(19) United States
(12) Patent Application Publication
(10) Pub. No.: US 2009/0272754 A1
(43) Pub. Date: Nov. 5, 2009

(54) Fastening Device for a Logistic Container and Logistic Container Implementing Such Device

(75) Inventors: Bernard Timmer, Conflans Saint-Honorine (FR); Jean-Noël Patry, Voisins le Bretonneux (FR)

Correspondence Address: OLIFF & BERRIDGE, PLC, P.O. BOX 320850, ALEXANDRIA, VA, 22320-4850, US

(73) Assignee: NEXTER SYSTEMS, Roanne (FR)

(21) Appl. No.: 12/085,317

(22) PCT Filed: Nov. 13, 2006
(86) PCT No.: PCT/FR2006/002508

§ 371 Date: Jun. 6, 2008

(30) Foreign Application Priority Data
Nov. 21, 2005 (FR) 0511744

(51) Int. Cl. B65D 43/16; B60R 9/00; B65D 90/00

(52) U.S. Cl. 220/810; 224/567; 220/694

(57) ABSTRACT

A device to fasten a logistic container (1) onto a structure (9), such as a vehicle, such device wherein it incorporates means (16, 12a, 24) to ensure the positioning of the container with respect to the structure and means (17, 25, 26) ensuring the locking of the container onto the structure and logistic container implementing such a device.

### BACKGROUND OF THE INVENTION

1. Field of the invention

The technical scope of the invention is that of logistic containers, and more particularly that of devices enabling such containers to be fastened to a structure, for example to a military vehicle.

2. Description of the related art

Such containers are a classical accessory enabling the on board capacity of a vehicle to be increased.

Most of the time, they cannot be placed inside the vehicle and must be fastened simply and reliably to the exterior of the vehicle.

These containers must be able to be fastened on using a device which ensures the attachment is both reliable and secure.

Containers are generally bulky and heavy components, so the device must also enable the mounting and dismounting operations to be facilitated.

Furthermore, it is desirable for the device to enable the container to be attached to different types of vehicles with minimal modifications required to the latter's structure.

### SUMMARY OF THE INVENTION

The aim of the invention is to propose a device to facilitate the attachment of a logistic container onto all types of structures or vehicles.

The invention also proposes a container implementing such a device and therefore able to be easily fastened to different vehicles and in different orientations.

Thus, the invention relates to a device to fasten a logistic container onto a structure, such as a vehicle, such device wherein it incorporates means to ensure the positioning of the container with respect to the structure and means ensuring the locking of the container onto the structure.

According to a first embodiment, the positioning means comprise at least one guiding ramp integral with the structure and cooperating with a bar integral with the container.

The positioning means may also comprise at least one bearing surface integral with the structure and cooperating with a surface on the container.

For this embodiment, the locking means may comprise at least one draw-pull fastener integral with the structure and cooperating with a catch integral with the container.

Advantageously, the fastening device will incorporate a support for the container which will be linked to the structure by attachment means, such support incorporating a base onto which the guiding ramp or ramps will be attached as well as the draw-pull fastener or fasteners.

The attachment means may incorporate remotely-controlled unlocking means.

The support may incorporate a cylindrical barrel which will be positioned on a cradle of matching shape and integral with the structure, the attachment means incorporating at least one flexible strap encircling part of the barrel.

According to another embodiment, the positioning means may comprise at least one bearing surface integral with the structure and cooperating with a metal strip integral with the container.

In this case, the joining means may comprise at least one pierced lug integral with the container and cooperating with a matching lug integral with the structure.

The joining means will also comprise a rod passing through the container's lug or lugs and the structure's lug or lugs.

The fastening device will in this case incorporate a plate integral with the structure, such plate incorporating at least one lock lug and a slot constituting the bearing surface.

The plate may also carry a mounting intended to receive a locking finger cooperating with an eye integral with the metal strip.

The invention also relates to a logistic container implementing such a fastening device, such container wherein it incorporates on at least one of its faces a positioning metal strip and on another face, contiguous with the previous one, at least one locking lug.

Preferably, this logistic container will incorporate a positioning metal strip on two parallel faces arranged on either side of a flap giving access to the inside of the container.

The container may incorporate four locking lugs arranged on a face that is perpendicular to the two faces carrying the metal strips.

The container may also incorporate on one of its faces at least one bar whose ends extend on either side of the container.

The container may lastly incorporate on the face carrying the bar at least one clasp enabling the locking of a draw-pull fastener.

### BRIEF DESCRIPTION OF THE DRAWINGS

Other advantages of the invention will become more apparent from the following description of a particular embodiment, such description made with reference to the appended drawings, in which:

FIG. 1 shows a frontal three-quarter perspective view of a with all its opening flaps closed,

FIG. 2 shows a rear three-quarter perspective view of this same container,

FIG. 3 shows two of these containers fastened to a wall using a first embodiment of a device according to the invention,

FIGS. 4a to 4c are different perspective views of clasping means carried by the wall,

FIGS. 5a and 5b show two phases in the attachment of a container to the rear part of an armored vehicle,

FIGS. 6 to 8 are detailed views of the container's clasping means,

FIG. 9 shows a lateral view of the container fastened to the rear of an armored vehicle,

FIG. 10 shows a container fastened to a structure using a second embodiment of a fastening device according to the invention,

FIG. 11 shows the part of this device which is integral with the structure.

### DETAILED DESCRIPTION OR PREFERRED EMBODIMENTS

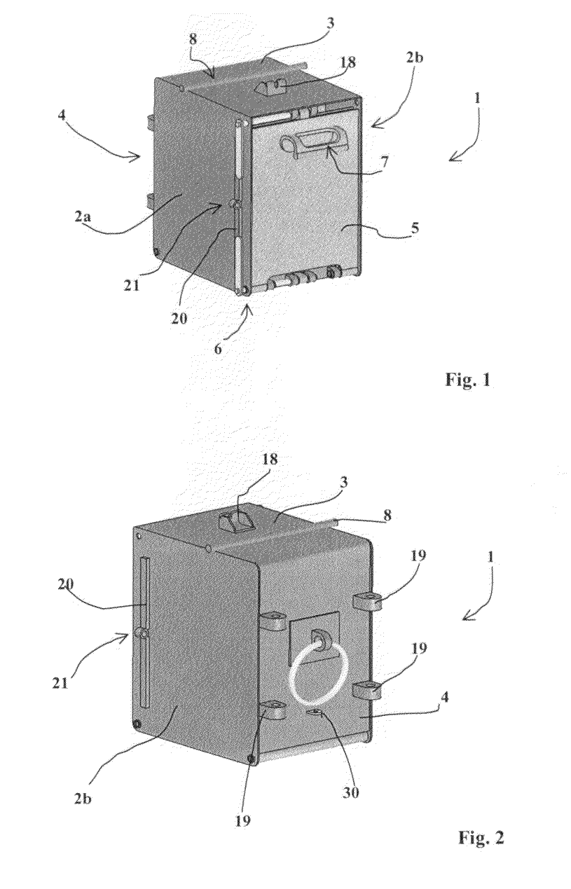

With reference to FIG. 1, a logistic container 1 is parallelepipedic in shape and thus incorporates six faces. It comprises a mechanically-welded frame which is formed by: the lateral faces 2a and 2b, the upper face 3 and the rear face 4. Two pivoting opening flaps are attached to this mechanically-welded structure which forms the container body: one front flap 5, fitted with a handle 7, and one lower flap 6.

Each flap constitutes one face of the parallelepiped. The front flap 5 is parallel to the rear face 4, the lower flap 6 is parallel to the upper face 3. The flaps are thus arranged on contiguous faces perpendicular to one another.

Each flap is mounted able to pivot with respect to a hinge. This container is shown in a first orientation. It is fastened to a structure such as a vehicle wall (not shown) by a fastening device.

According to a first embodiment, the device comprises a transversal bar 8 which is integral with the upper face 3 of the container.

This bar is welded to the upper face 3 and it protrudes slightly on either side of the container beyond lateral faces 2a and 2b.

It is intended to cooperate with matching clasping means integral with the vehicle structure.

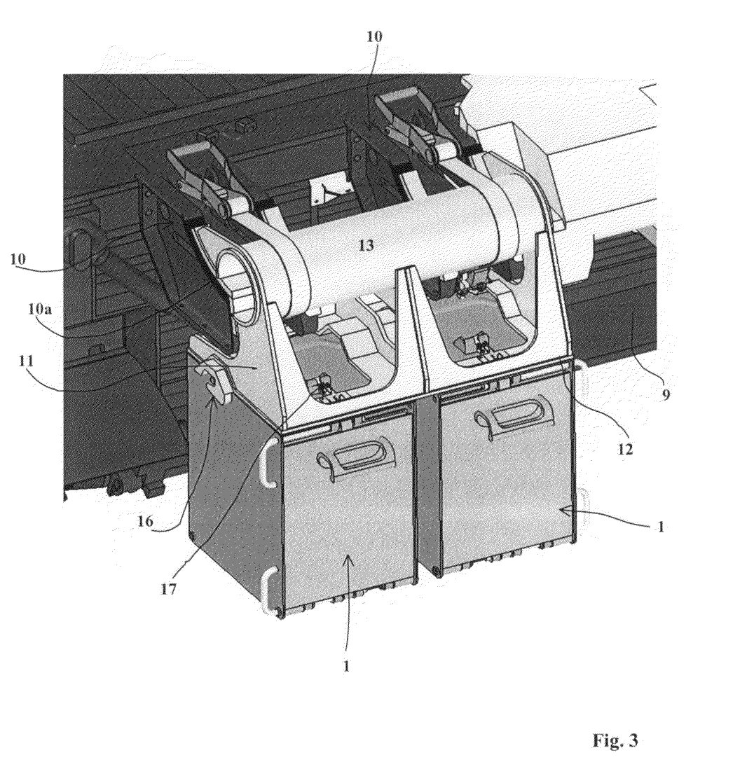

FIG. 3 shows the rear end of an armored vehicle 9. The latter incorporates a pair of cradles which receive a support for the container 11.

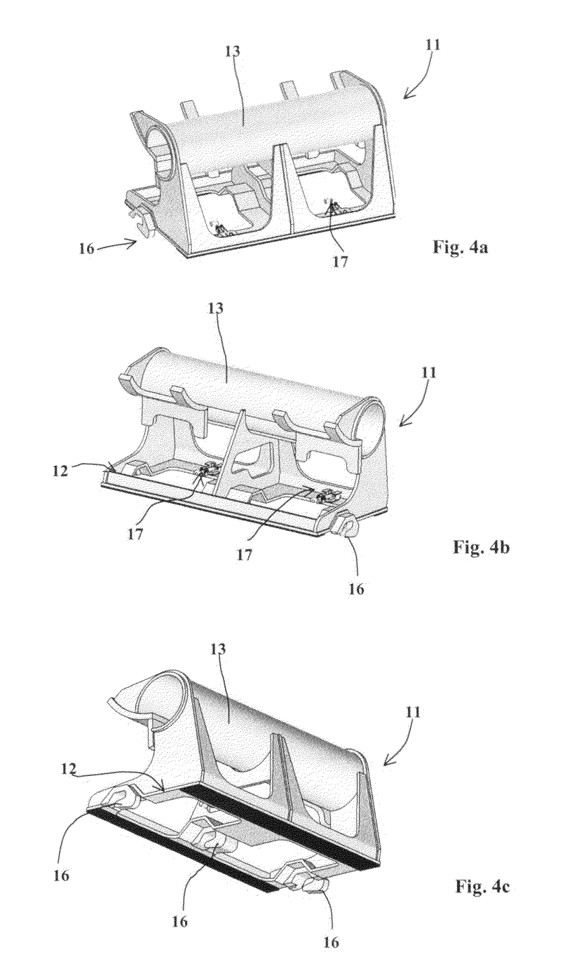

This support 11 comprises a base 12 integral with a cylindrical barrel 13 which is positioned on the cradle 10 (see FIGS. 4a to 4c).

The latter are of a shape that matches the barrel 13. One layer 10a of shock-absorbing material, for example rubber, may be fastened to the cradle and will provide shimming for the barrel 13 (see FIG. 3).

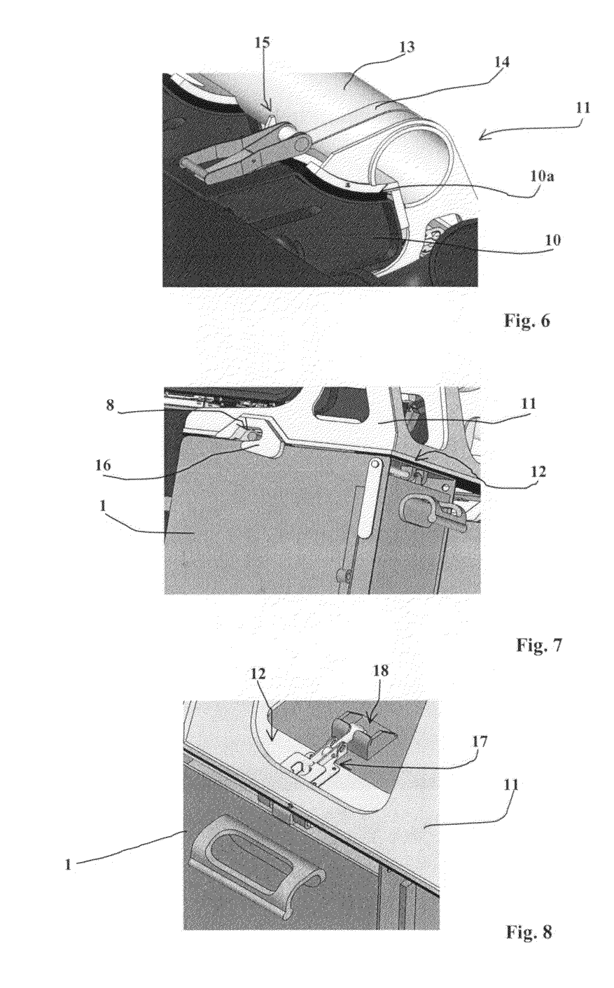

The barrel 13 is made integral with the vehicle 9 by attachment means which here incorporate two flexible straps whose ends are integral with the vehicle and which encircle part of the barrel. The straps incorporate rotating ratcheting tensioners 15 of a classical type which do not need to be described in detail (FIG. 6).

As may be seen more particularly in FIG. 4c, the base 12 carries three guiding ramps 16, one median ramp and two end ramps. The median ramp is larger than the end ramps.

The support 11 is intended to receive two containers 1. Ramps 16 take on the shape of the clasps and they receive the ends of the bars 8 integral with the two containers 1.

Each bar 8 is thus positioned between an end ramp and the median ramp.

The ramps constitute means to ensure the positioning of the container with respect to the structure.

Furthermore, the base 12 carries locking means for each container which comprise two draw-pull fasteners 17 integral with the upper wall of the base 12 (see FIGS. 4b and 8). Each draw-pull fastener 17 cooperates with a clasp 18 integral with the upper wall 3 of a container 1.

The positioning means for the container 1 also comprise a bearing surface which is constituted by the lower face 12a of the base 12 which comes into contact with the upper wall 3 of the container 1.

This bearing surface will advantageously carry a layer of shock-absorbing material (for example rubber).

Thus, in accordance with the invention, the fastening device firstly comprises means to ensure the positioning of the container with respect to the structure (the ramps 16 receiving the bar 8 and the bearing surface 12a) and means ensuring that the container is locked onto the structure (the draw-pull fasteners 17).

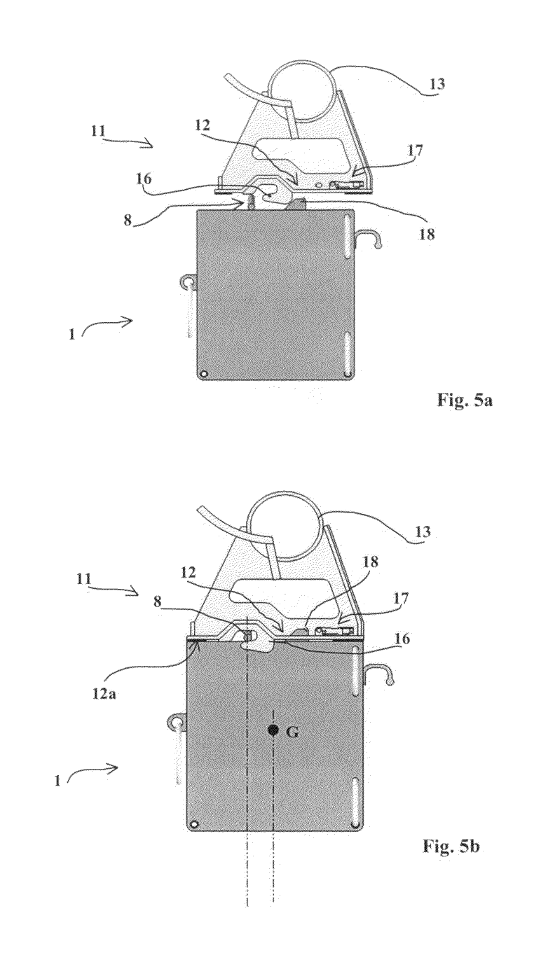

Such an arrangement makes it easier to attach heavy or bulky containers. Indeed, to attach a container to a vehicle, its bar 8 is firstly positioned on the ramps 16 (see FIG. 5a).

The upper face 3 of the container then comes to press on the lower face 12a of the base 12 (see FIG. 5b). The container is thus reliably positioned with respect to the support without any risk of falling. The container's centre of gravity G is located between the bar 8 and the front flap 5. The resulting tilting of the container ensures that it presses on face 12a between the bar and rear face 4 preventing the container from slipping on the ramps 16.

It is then fastened into place by means of the draw-pull fastener 17.

So as to enable the rapid removal of the containers in the field, attachment means comprising a strap may be used which incorporate remotely-controlled unlocking means.

Such means implement an electro-magnet known, for example, by patent FR2715218 and does not therefore require any further description here.

By way of a variant, the exterior face of the lower flap 6 may be coated with elastomer. Such a variant will enable it to be protected from the effects of its impacting on the ground when the container is unhooked from its vertical position.

It is naturally possible to define a support which only accommodates one container 1.

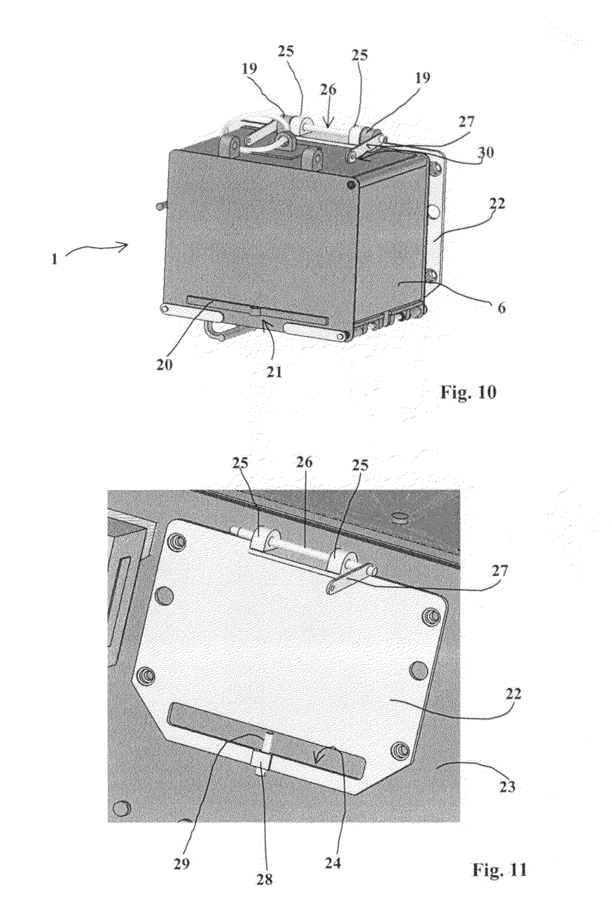

FIGS. 10 and 11 show another embodiment of a fastening device according to the invention.

This mode of fastening implements joining means which are also partly integral with the container 1 such as shown in FIGS. 1 and 2.

The container 1 thus comprises four evenly spaced lugs 19 on its rear face. These lugs are pierced and can cooperate with matching means integral with the vehicle's structure.

Furthermore, the lateral faces 2a and 2b of the container each carry a welded metal strip 20 fitted with an eye 21.

FIG. 11 shows the part of this fastening device which is integral with the vehicle. This part comprises a plate 22 made integral with the structure 23 by screws.

Plate 22 incorporates at its rear part a substantially rectangular slot 24. It has two lugs 25 at its upper part in which a rod 26 carrying a lever 27 is positioned.

The plate 22 furthermore has a mounting 28 positioned substantially centrally to the slot 24. A removable finger 29 can be positioned in the mounting 28.

According to this embodiment of the invention, the slot 24 constitutes the positioning means for the container. Indeed, the slot forms a bearing surface which cooperates with a metal strip 20.

When the container 1 is mounted in the position shown in FIG. 10, a metal strip 20 is thus positioned at the slot 24 (the one integral with face 2a).

Such an arrangement provides a support for the container thereby facilitating its mounting. When the container is thus positioned, the lugs 19 on its rear face 4 are positioned on either side of the lugs 25 on plate 22 (see FIG. 10). A rod 26 is thereafter positioned through the holes in the lugs 19 and 25 thereby joining the container and the plate 22.

The end of the lever 27 is thus positioned opposite a pierced tongue 30 integral with the rear face 4. It is thus possible to put into place locking means (such as a padlock) to prevent the container 1 from being dismounted.

After the rod 26 has been put into position, the finger 29 is placed in the eye 21 and the mounting 28 thereby completely locking the container.

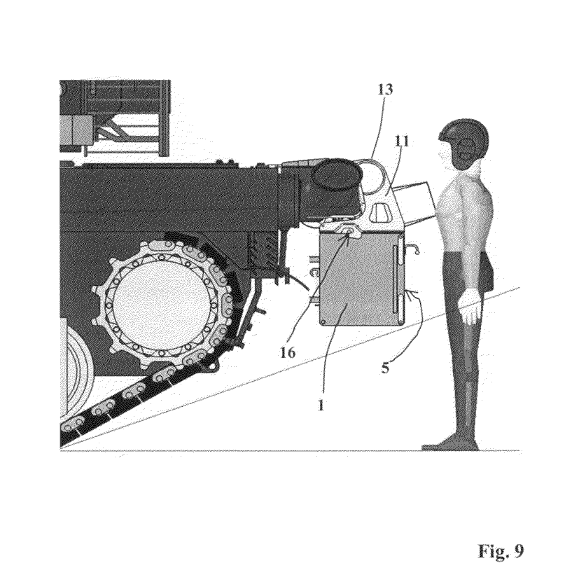

We note that in FIG. 9 the container is arranged in a vertical orientation in which it is flap 5 which provides access to the content of the container 1.

In FIG. 10, however, the container is arranged in a horizontal orientation in which it is flap 6 which is oriented to the right and provides access to the content of the container 1.

Furthermore, depending on the constraints linked to the vehicle it is possible for flap 6 to be placed either to the right or to the left. Indeed, the clasping means are symmetrical, rear face 4 thus has four identical lugs 19 and each lateral face 2a, 2b has a metal strip 20.

It is possible for only one or other of the previously described fastening means to be implemented. In this case, the container will be made to have a flap arranged appropriately.

It will be advantageous, however, to provide (as is the case here) a container having at least two different fastening devices. Indeed, such an arrangement increases the possibilities of its integration onto a vehicle. In this case, it will be necessary to provide at least two flaps so that, whatever the orientation of the container (horizontal or vertical) it is possible to access its content without needing to dismount it.

The container as described above may be positioned according three different directions, one vertical direction and two horizontal directions.

The invention has been described here for the case of the attachment of a logistic container onto a vehicle wall. Naturally the fastening device according to the invention may be used to fasten any type of organ onto any type of fixed or mobile, land, air or naval structure.

1. A device to fasten a logistic container onto a structure such as a vehicle, wherein said device incorporates positioning means to ensure the positioning of said container with respect to said structure and locking means ensuring the locking of the container onto said structure.

2. A fastening device according to claim 1, wherein the said positioning means comprise at least one guiding ramp integral with said structure and cooperating with a bar integral with said containers.

3. A fastening device according to claim 2, wherein said positioning means comprise at least one bearing surface integral with said structure and cooperating with a surface on said container.

4. A fastening device according to claim 1, wherein the locking means comprise at least one draw-pull fastener integral with said structure and cooperating with a catch integral with said containers.

5. A fastening device according to claim 4, wherein said device incorporates a support for said container which will be linked to the structure by attachment means, such said support incorporating a base onto which said guiding ramp or ramps (16) will be attached as well as said draw-pull fastener or fasteners.

6. A fastening device according to claim 5, wherein said attachment means incorporate remotely-controlled unlocking means.

7. A fastening device according to claim 5, wherein said support incorporates a cylindrical barrel which is positioned on a cradle of matching shape and integral with said structure, said attachment means incorporating at least one flexible strap encircling part of said barrel.

8. A fastening device according to claim 1, wherein said positioning means comprise at least one bearing surface integral with said structure and cooperating with a metal strip integral with said container.

9. A fastening device according to claim 8, wherein t said device comprises joining means made of at least one pierced lug integral with said container and cooperating with a matching lug integral with said structure.

10. A fastening device according to claim 9, wherein the said joining means comprise a rod passing through said pierced lug or lugs of said container and said matching lug or lugs of said structure.

11. A fastening device according to claim 8, wherein said device incorporates a plate integral with said structure, such plate incorporating at least said one matching lug and a slot constituting said bearing surface.

12. A fastening device according to claim 11, wherein said plate carries a mounting intended to receive a locking finger cooperating with an eye integral with said metal strip.

13. A logistic container implementing a fastening device according to claim 1, wherein said container incorporates on at least one of its faces a positioning metal strip and on another face, contiguous with the previous one, at least one locking lug.

14. A logistic container according to claim 13, wherein said container incorporates a positioning metal strip on its two parallel faces arranged on either side of a flap giving access to the inside of said container.

15. A logistic container according to claim 14, wherein said container incorporates four locking lugs arranged on a face that is perpendicular to the two faces carrying said metal strips.

16. A logistic container according to claim 13, wherein said container incorporates on one of its faces at least one bar whose ends extend on either side of said container.

17. A logistic container according to claim 16, wherein said container incorporates on the face carrying said bar at least one clasp enabling the locking of a draw-pull fastener.
